(19) United States
(12) Patent Application Publication
(10) Pub. No.: US 2001/0003480 A1
(43) Pub. Date: Jun. 14, 2001

(54) Apertures and illuminating apparatus including aperture openings dimensioned to compensate for directional critical dimension differences

(76) Inventors: Heung-jo Ryuk, Kyungki-do (KR); Ji-yong Yoo, Kyungki-do (KR)

Correspondence Address: Grant J. Scott, Myers Bigel Sibley & Sajovec, Post Office Box 37428, Raleigh, NC, 27627, US

(21) Appl. No.: 09/728,464

(22) Filed: Dec. 1, 2000

(30) Foreign Application Priority Data
Dec. 6, 1999 (KR) 99-55203

(51) Int. Cl. G03B 27/42; G03B 27/54

(52) U.S. Cl. 355/53; 355/67

(57) ABSTRACT

Apertures for use in an illuminating apparatus for forming patterns in a semiconductor wafer and illuminating apparatus including such apertures are provided. The aperture includes a shielding area and a non-circular transparent area within the shielding area. The transparent area has a ratio of a short axis to a long axis (R=short axis/long axis) that exceeds 0 and is smaller than 1 (0<R<1), the short axis being substantially perpendicular to the long axis. The transparent area may have an elliptical shape with an eccentricity (e) that exceeds 0 and is smaller than 1 (0<e<1). The transparent area may be positioned within the shielding area to define two thin portions of the shielding area and two thick portions of the shielding area with the long axis linking the thin portions of the shielding area and the short axis linking the thick portions of the shielding area.

### RELATED APPLICATIONS

This application is related to Korean Application No. 99-55203, filed Dec. 6, 1999 the disclosure of which is hereby incorporated herein by reference.

### BACKGROUND OF THE INVENTION

The present invention relates to apertures and illuminating apparatus used for manufacturing semiconductor devices, and more particularly, to apertures and illuminating apparatus having a scan and a slit direction associated with horizontal and vertical features.

Manufacturing of semiconductor devices typically includes operations involving replication of patterns from a mask onto the surface of a device substrate. This replication process may be performed, for example, using optical lithography methods followed by a variety of etching or deposition processes as appropriate to the desired resultant semiconductor device. Optical lithography patterning generally involves illumination by a light source of a mask which contains a magnified image of the pattern to be etched into a target wafer. The illuminated image is thus reduced in size and patterned onto a photosensitive film on the device substrate. However, as the density of integration of such semiconductor devices increases, the demands on the resolution of illuminating apparatus for use in such processes increases.

Known approaches to increasing the resolution of an illuminating apparatus for use in processes such as optical lithography include increasing a numerical aperture associated with the illuminating apparatus and using a short wavelength light source. Typically, increasing a numerical aperture in the illuminating apparatus requires enlarging the diameter of a lens in the optical path so that the oblique incidence angle of light from the light source is large. However, technology and space limitations may make it difficult to enlarge the diameter of such a lens in an illuminating apparatus. In addition, as the diameter of a lens in such an apparatus is enlarged, the depth of focus for the illuminating apparatus is typically lowered which may make it difficult to use this approach in the manufacturing process.

Use of a short wavelength light source may be provided, for example, using a light source emitting deep ultraviolet rays or having a shorter wavelength. This approach typically results in less of a decrease in the depth of focus characteristic of the illuminating apparatus than an approach relying on increasing the numerical aperture of the device. However, changes to the wavelength of the light source generally require replacement of existing photosensitive films used in a manufacturing process with new photosensitive films suitable for use with the new, shorter wavelength light source. Other problems may arise from changes in wavelength associated with a light source for the illuminating apparatus as well, creating further problems in introducing such an approach in a practical manufacturing process. Both changes in the wavelength of the light source and the numerical aperture of the device may well require existing illuminating apparatus in production facilities to be replaced with new illuminating apparatus resulting in a significant cost. Other proposed approaches use a phase inversion mask and off-axial illumination.

Referring to FIG. 1, an illuminating apparatus used for manufacturing a semiconductor apparatus is usually composed of a plurality of optical devices including a light source 10. An aperture 12 is provided that restricts incident light from the light source 10. The aperture 12 may be a circular, annular or quadruple aperture. A condenser lens 14 is provided below the aperture 12. A mask 16 is aligned below the condenser lens 14. Below the mask 16, a projection lens 18 is provided for transferring a pattern inscribed on the mask 16 to a target wafer W. The wafer W is loaded on a stage 20 which is provided below the projection lens 18. A plurality of other optical devices including, for example, a reflector, may also be provided between the aperture 12 and the light source 10. The method used by the apparatus may vary, for example, based on what type of aperture 12 is used.

Referring now to FIG. 2, a conventional circular aperture 21 is illustrated which includes a transparent area 23 at the center of a shielding area 22. The shielding area 22 shields light incident on the condenser lens 14 spaced away from an optical axis, that is, off-axial light. Accordingly, most light passing through the transparent area 23 goes by the optical axis of the illuminating apparatus or a paraxial area in the vicinity of the optical axis. As described above, when a circular aperture is used, because light used for illumination is generally restricted to paraxial rays, illumination using an illuminating apparatus provided with a circular aperture may be referred to as paraxial illumination.

Referring now to FIG. 3, a conventional annular aperture 24 is shown which includes a circular transparent area 26 in a first shielding area 25 and a circular second shielding area 27 at the center of the circular transparent area 26. In an illuminating apparatus using such an annular aperture, among the incident light going into the condenser lens 14, rays progressing along the optical axis of the illuminating apparatus, that is, chief rays passing through the optical axis of the condenser lens 14, and peripheral paraxial rays are shielded by the second shielding area 27. It is mostly off-axial light rays spaced away from the optical axis that pass through the annular aperture 24. Accordingly, an illuminating method using an illuminating apparatus having the annular aperture 24 may be referred to as an off-axial illuminating method.

Referring now to FIG. 4, a conventional quadrupole aperture 28 is shown which includes four circular transparent areas 31 in a shielding area 30. Here, the transparent areas 31 are positioned symmetrically around the aperture 28 between the center and the circumference of the aperture 28. Accordingly, an illuminating method using an illuminating apparatus having the quadrupole aperture 28 may be referred to as an off-axial illuminating method as well. However, because the quadrupole aperture 28 typically restricts off-axial light rays more than the annular aperture 24, the intensity of radiation used for illumination may decrease.

A scanner type illuminating apparatus having slits extending in a direction perpendicular to a scan direction as shown in FIGS. 3 and 4 may be useful in forming patterns having a small pitch on to a wafer W. Such a scanner type apparatus may include apertures such as those shown in FIGS. 3 and 4. However, when perpendicular patterns are formed in the scan and slit directions, the critical dimension (CD) between a pattern formed in the scan direction and a pattern formed in the slit direction may differ. The resulting CD difference may become greater as the pitches of the masked patterns decrease. Accordingly, as the integration density of a semiconductor device increases, the CD difference caused by the illuminating method may increase. This is generally because light diffracted by the patterns formed in the slit direction and used for exposure of a photosensitive film on a wafer will differ from light diffracted by the patterns formed in the scan direction.

This problem is shown in FIG. 5 which illustrates light which may be diffracted by patterns formed in a slit direction and a scan direction when a portion of patterns inscribed on a mask is scanned by a typical scanner type illuminating apparatus. A mask M, a pattern formation area P of the mask M and a slit S are shown in FIG. 5. The scan direction 38 is from left to right in FIG. 5. A first pattern P1 is shown formed in the scan direction 38 and a second pattern P2 is shown formed in a slit S direction, respectively, in the pattern formation area P.

FIG. 6 illustrates a cross-sectional view taken along the line 6-6′ of FIG. 5 (i.e., in the scan direction) to show the diffraction characteristics of light diffracted by the patterns formed in the scan direction. Note that only 0th order light R₀ and ±1st order light R_{±1} among light diffracted by the first patterns P1 formed in the scan direction is used for exposure of the photosensitive film. This is typically both because the angle of diffraction of high order diffracted light is made larger with a decrease in a pattern pitch and because the scan area of a lens meter L below the mask M is generally narrowed due to the presence of the slit S. Thus, ±2nd order or higher diffracted light generally cannot be used for the exposure of the first pattern P1 formed in the scan direction.

FIG. 7 illustrates a cross-sectional view taken along the line 7-7′ of FIG. 5 (i.e., in the slit direction) to show the diffraction characteristics of light diffracted by the patterns formed in the slit direction. Note that ±2nd order or higher order light as well as 0th order light R₀ and ±1st order light R_{±1} from among light diffracted by the second patterns P2 formed in the slit direction is used for exposure of the photosensitive film. This differs from the first pattern P1 formed in the scan direction.

In transferring patterns inscribed on a mask, the patterns generally can be more exactly transferred by using higher order light from among the light diffracted from the patterns. Accordingly, the second patterns P2 are typically more accurately transferred to the wafer surface than the first patterns P1. Such a difference may result where incident light is diffracted with a large angle as the pitches of the second patterns P2 are decreased, as with the first patterns P1. However, the lens meter L is typically more exposed in the slit direction so that the scan area of the lens meter L is wider in this direction. Thus, as light diffracted by the first patterns P1 formed in the slit direction and used for exposure is generally different from light diffracted by the second patterns P2 formed in the scan direction and used for exposure, a CD difference between their transferred patterns may result.

In addition, it can be seen from the following Table 1 that the CD differences between patterns formed perpendicular to each other in a slit direction and a scan direction may be different from each other when different scanner type illuminating apparatuses are used, even if the different illuminating apparatuses use the same mask and the same aperture. However, the CD differences may be the same when the same scanner type illuminating apparatus uses different apertures.

TABLE 1

| Illuminating apparatus/aperture | CD difference (H-V) between |
|---|---|
| (diameter) | perpendicular patterns |
| A company/circular type (0.8 σ) | −5 nm |
| B company/circular type (0.8 σ) | +15 nm |
| B company/annular type (0.8 σ) | +15 nm |
| B company/circular type (0.6 σ) | +15 nm |

As shown in Table 1, A company's scanner type illuminating apparatus provided with a conventional circular aperture having a transparent area (which may be considered as the area of a light source emitting light having a coherence of about 0.8 σ) with a diameter of 0.8 sigma (the smaller this value is, the higher coherence is), has a CD difference between a pattern formed in the slit direction and a pattern formed in the scan direction of about −5 nm. In other words, the pattern formed in the slit direction is narrower than the pattern formed in the scan direction by about 5 nm. B company's illuminating apparatus under the same conditions as A company's illuminating apparatus, that is, employing the same mask and the same aperture, has a CD difference of about +15 nm. In other words, the pattern formed in the slit direction is wider than the pattern formed in the scan direction by about 15 nm. When the conventional circular aperture having a transparent area exhibiting a coherence of about 0.8 σ is replaced with a conventional annular aperture having a transparent area exhibiting a coherence of about 0.6 σ in the B company's illuminating apparatus, the CD of a pattern in the slit direction is wider than the CD of a pattern in the scan direction by about 15 nm. In other words, the CD difference between the perpendicular patterns is still about +15 nm.

### SUMMARY OF THE INVENTION

Embodiments of the present invention include apertures for use in an illuminating apparatus for forming patterns in a semiconductor wafer and illuminating apparatus including the apertures. The aperture includes a shielding area and at least one transparent area within the shielding area. The transparent area may have an elliptical shape with an eccentricity (e) that exceeds 0 and is smaller than 1 (0<e<1).

Two or more, for example, four, of the elliptical transparent areas may be provided within the shielding area. In various embodiments a second shielding area is provided within the elliptical transparent area. The second shielding area may be a circular shielding area centered in the elliptical transparent area. Where a plurality of transparent areas are provided, they may be positioned at angular intervals of 90° within the shielding area. Each of the transparent areas may have the same eccentricity (e). The eccentricity (e) may be selected to provide a desired maximum critical dimension difference between directions of the patterns.

In other embodiments of the present invention, apertures for use in an illuminating apparatus for forming patterns in a semiconductor wafer are provided. The apertures include a shielding area and a non-circular transparent area within the shielding area. The transparent area has a ratio of a short axis to a long axis (R=short axis/long axis) that exceeds 0 and is smaller than 1 (0<R<1). The short axis is substantially perpendicular to the long axis. The transparent area is positioned within the shielding area to define two thin portions of the shielding area and two thick portions of the shielding area, the long axis linking the thin portions of the shielding area and the short axis linking the thick portions of the shielding area.

The long axis may have a 0.8 sigma (σ) length and the short axis may have a 0.6 sigma (σ) length or a 0.7 sigma (σ) length. The shielding area may be circular. In various embodiments, a second shielding area is provided within the transparent area. The second shielding area may be a circular shielding area centered in the transparent area.

In further embodiments of the present invention, illuminating apparatus are provided for forming patterns in a semiconductor wafer. The illuminating apparatus includes a wafer stage and a light source positioned above the wafer stage. An aperture is positioned between the light source and the wafer stage. A mask is positioned between the aperture and the wafer stage and a slit is positioned between the aperture and the wafer stage. The aperture includes a shielding area and at least one transparent area within the shielding area. The transparent area in various embodiments has an elliptical shape with an eccentricity (e) that exceeds 0 and is smaller than 1 (0<e<1). In further embodiments, a non-circular transparent area is provided within the shielding area which has a ratio of a short axis to a long axis (R=short axis/long axis) that exceeds 0 and is smaller than 1 (0<R<1) with the short axis being substantially perpendicular to the long axis. In such embodiments, the transparent area may be positioned within the shielding area to define two thin portions of the shielding area and two thick portions of the shielding area with the long axis linking the thin portions of the shielding area and the short axis linking the thick portions of the shielding area.

The illuminating apparatus may further include a condenser lens positioned between the aperture and the mask. In addition, a projection lens may be positioned between the slit and the wafer stage. The aperture may be aligned so that a long axis of the transparent area is perpendicular to a lengthwise direction of the slit.

In other embodiments of the present invention, illuminating apparatus are provided for forming patterns in a semiconductor wafer. The illuminating apparatus include a wafer stage and a light source positioned above the wafer stage. An aperture is positioned between the light source and the wafer stage. A mask is positioned between the aperture and the wafer stage and a slit is positioned between the aperture and the wafer stage. The slit has a lengthwise axis perpendicular to a scan direction of the illuminating apparatus. The aperture includes a shielding area and a non-circular transparent area within the shielding area. The transparent area has a ratio of a short axis to a long axis (R=short axis/long axis) that exceeds 0 and is smaller than 1 (0<R<1) with the short axis being substantially perpendicular to the long axis. The slit moves relative to the mask in the scan direction during forming of the patterns and the aperture is aligned so that the long axis of the transparent area is perpendicular to the lengthwise axis of the slit.

As described above, when patterns inscribed on a mask are transferred, high order diffracted light from among the light diffracted by the patterns can be used in accordance with embodiments of the present invention by appropriately applying an aperture including a non-circular transparent area to an illuminating apparatus, such as a scanner type illuminating apparatus, based on a slit direction. Accordingly, the critical dimension difference between patterns formed in different directions can be minimized.

### BRIEF DESCRIPTION OF THE DRAWINGS

The above aspects of the present invention will become more apparent by describing embodiments thereof with reference to the following accompanying drawings:

FIG. 1 is a schematic diagram illustrating a conventional illuminating apparatus used for manufacturing a semiconductor device;

FIGS. 2 through 4 are plan views illustrating apertures which can be used in a conventional illuminating apparatus used for manufacturing a semiconductor device;

FIG. 5 is a plan view illustrating light diffracted by patterns formed in the slit and scan directions of a mask during exposure using a scanner type illuminating apparatus;

FIG. 6 is a cross-sectional view taken along line 6-6′ of FIG. 5;

FIG. 7 is a cross-sectional view taken along line 7-7′ of FIG. 5;

FIG. 8 is a simulation based graph illustrating changes in critical dimensions by pattern pitches when the circular aperture of FIG. 2 is applied to a conventional scanner type illuminating apparatus used for manufacturing a semiconductor device;

FIG. 9 is a graph illustrating the results of surveying changes in the critical dimensions of patterns by pitches during photolithography using a conventional scanner type illuminating apparatus including the circular aperture of FIG. 2 for manufacturing a semiconductor device;

FIGS. 10 through 12 are plan views of apertures according to various embodiments of the present invention;

FIG. 13 is a schematic diagram illustrating an illuminating apparatus for forming patterns in a semiconductor wafer according to embodiments of the present invention; and

FIG. 14 is a plan view illustrating the alignment of a slit and an aperture in an illuminating apparatus according to embodiments of the present invention.

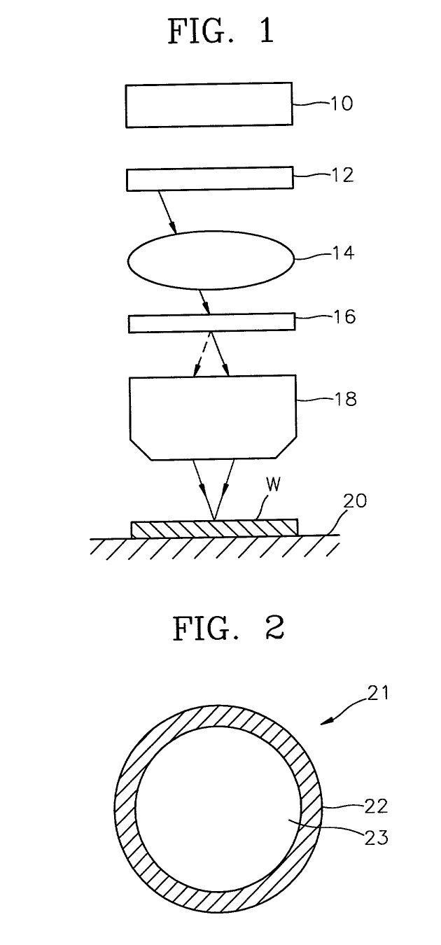

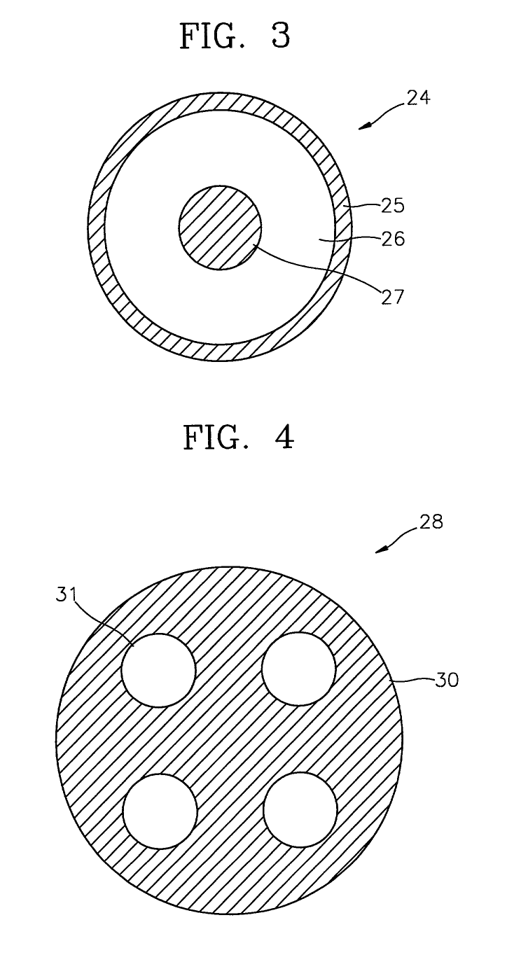

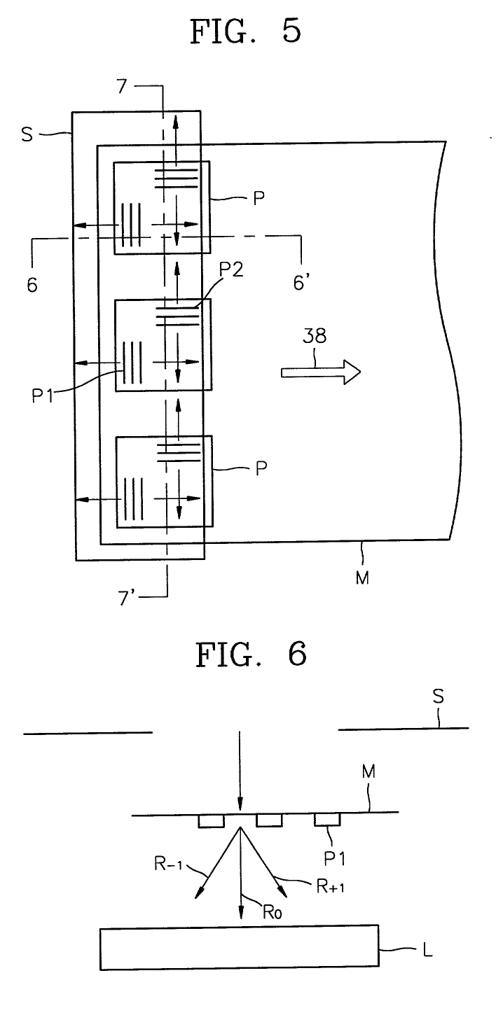

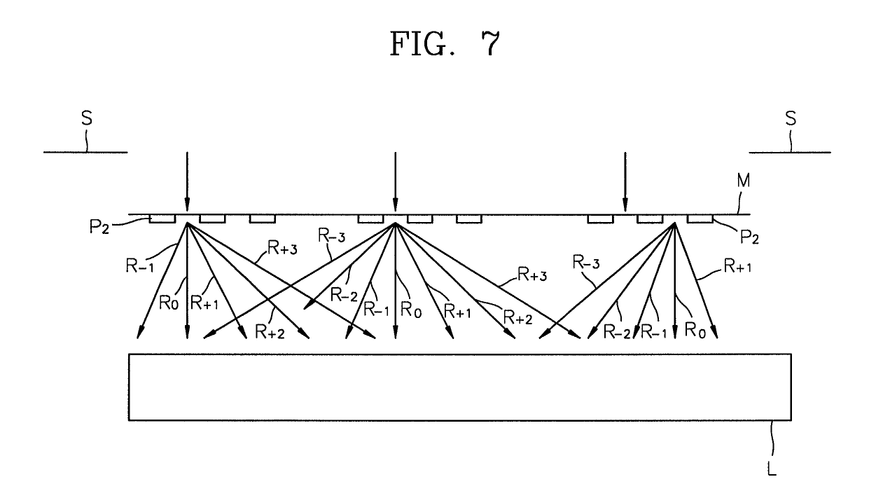

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of layers and the width of areas are exaggerated for clarity, and the same reference numerals denote the same member.

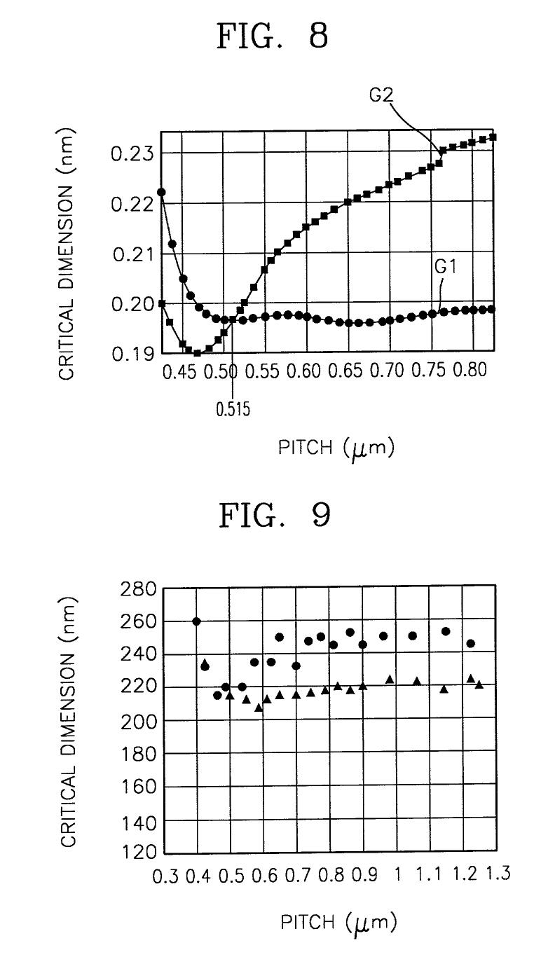

Before further describing apertures according to embodiments of the present invention, results of simulating changes in the critical dimensions of patterns by pitches depending on changes in the transparent area of a conventional circular aperture will be described. As shown in FIG. 8, reference character G1 denotes a first simulation graph illustrating changes in a critical dimension by pattern pitches when a conventional circular aperture in which the diameter of a transparent area is 0.8 sigmas (σ) is used. Reference character G2 denotes a second simulation graph obtained when a conventional circular aperture in which the diameter of a transparent area is 0.6 σ is used.

As shown in the first and second simulation graphs G1 and G2, when a conventional circular aperture having a diameter of a transparent area is 0.8 σ is used, the critical dimension is smaller than 0.20 nanometers (nm) when the pattern pitch exceeds 0.50 μm. When the diameter of the transparent area is 0.6 σ, the critical dimension is 0.20 nm or larger at the same pattern pitch as compared to a diameter of 0.8 σ. In addition, the 0.6 σ diameter case has a different slope. When the pitch of pattern is 0.51-0.52 μm, the critical dimensions for both diameters are substantially the same. Below this point, the critical dimension for a 0.6 σ diameter is smaller than that for a 0.8 σ diameter.

FIG. 9 illustrates data based on measurements of changes in the critical dimensions of patterns by pitches under the same conditions as the simulation data of FIG. 8. In FIG. 9, the symbol “▴” is used for results with a conventional circular aperture in which the diameter of a transparent area is 0.8 σ and the symbol “●” is used for results with a conventional circular aperture in which the diameter of a transparent area is 0.6 σ. Comparing FIGS. 8 and 9 shows that changes in the critical dimensions of a pattern are similar both for simulated and measured data. The present invention may result in providing a change in a critical dimension which is uniform regardless of the pattern pitch by increasing or decreasing the dimensions of a portion of the transparent area of an aperture. In other words, the critical dimension differences between patterns formed to be perpendicular to each other may be reduced. For example, referring to the first and second graphs G1 and G2 of FIG. 8, the variation of a critical dimension of a pattern resulting from a change in a pattern pitch can be decreased to 0.15-0.20 μm by decreasing the diameter of a portion of a transparent area to 0.6 σ in a circular aperture in which the diameter of the transparent area is 0.8 σ. Various embodiments of apertures in accordance with the present invention will now be further described. Note that, while the discussion herein is presented in the context of perpendicular directions at substantially right angles, the present invention is not so limited but may also be utilized for transverse features defined by axis intersecting at other angles.

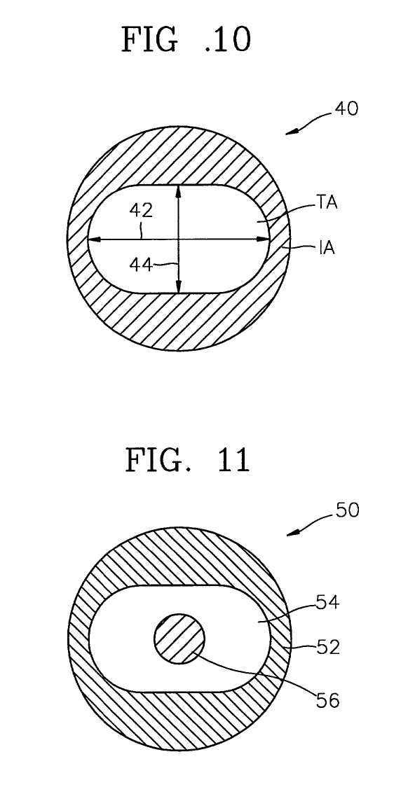

Referring first to FIG. 10, an aperture 40 according to embodiments of the present invention includes a shielding area IA whose outer shape is circular and a transparent area TA provided within the shielding area IA. The transparent area TA has a long axis 42 linking the two thin portions (the thinnest portions in FIG. 10) of the shielding area IA and a short axis 44 perpendicular to the long axis 42 and linking the two thick portions (the thickest portions in FIG. 10) of the shielding area IA. The ratio of the short axis 44 to the long axis 42 (R=short axis 44/long axis 42) in embodiments of the present invention exceeds 0 and is smaller than 1.

The long axis 42 and the short axis 44 may be 0.8 σ and 0.6 σ(or 0.8 σ and 0.7 σ), respectively, in length. 0.1 σ may be about 7 mm. Accordingly, the length of the long axis 42 is about 56 mm, and the length of the short axis 44 is about 42 mm (or 49 mm). The shape of the transparent area in the circular aperture 40 varies with the lengths of the long axis 42 and the short axis 44. For example, a circular aperture 40 may have an elliptical transparent area having an eccentricity “e” that exceeds 0 and is smaller than 1 (0<e<1). However, the transparent area TA may be other shapes, such as rectangular, in various embodiments.

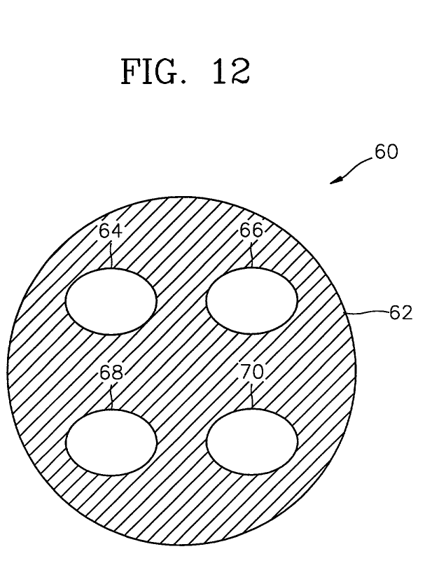

Referring now to FIG. 11, an aperture 50 according to further embodiments of the present invention is illustrated. The aperture 50 of FIG. 11 is an annular aperture which is similar to aperature 40 with the addition of a second shielding area. More specifically, the aperture 50 includes a transparent area 54, which may have the same shape as the transparent area TA provided for the aperture 40. The transparent area 54 is shown within a first shielding area 52. A second shielding area 56 is provided at the center of the transparent area 54. Accordingly, the aperture 50 differs from a conventional annular aperture at least in the shape of the transparent area. The aperture 50, like the aperture 40, has a long axis which, as shown in FIG. 11, passes through the center of the second shielding area 56 and links the thin portions of the first shielding area 52. A short axis passes through the center of the second shielding area 56 in FIG. 11 and links the thick portions of the first shielding area 52. The short axis, as shown in FIG. 11, is perpendicular to the long axis.

Referring now to FIG. 12, an aperture 60 according to yet further embodiments of the present invention is shown. The aperture 60 has at least two transparent areas, for example, a quadrupole aperture having four transparent areas as shown in FIG. 12. The aperture 60 may, otherwise, be similar to the aperture 40. More specifically, the aperture 60 includes first through fourth transparent areas 64, 66, 68 and 70 within a shielding area 62. As shown in FIG. 12, each of the first through fourth transparent areas 64, 66, 68 and 70 may have the same shape as the transparent area TA of the aperture 40. Accordingly, each of the first through fourth transparent areas 64, 66, 68 and 70 has a long axis, shown in FIG. 12 as passing through the center of the transparent area, and a short axis perpendicular to the long axis, shown in FIG. 12 as passing through the center of the transparent area. The first through fourth transparent areas 64, 66, 68 and 70 are positioned at angular intervals of 90° for the embodiments illustrated in FIG. 12.

Operations for forming patterns in a semiconductor wafer using embodiments of illuminating apparatus according to the present invention will now be described. Either a conventional circular, annular and quadrupole apertures is selected and positioned in a scanner type illuminating apparatus. Patterns formed on a mask in a scan direction and in a slit direction perpendicular to the scan direction are transferred to a substrate using the illuminating apparatus. The variations of critical dimensions of the transferred patterns are then measured. Data obtained by measuring the variations of critical dimensions of the transferred patterns is analyzed, and the diameter of a portion of the transparent area of the selected aperture is selected to have a different value from the other portions. In other words, a new aperture having non-circular transparent area(s) is selected. This new aperture is positioned in an illuminating apparatus, and the measurement and the data analysis operations are repeated. With such an approach, an aperture which reduces a change in the critical dimension of a pattern depending on a pattern pitch and which reduces the variations of the critical dimensions of a pattern formed in the slit direction and a pattern formed in the scan direction perpendicular to the slit direction may be provided.

For an aperture having at least two independent transparent areas, the shape of all the transparent areas may be provided with a uniform non-circular shape. For example, in the case of a quadrupole aperture, the shape of all the four transparent areas may be changed into a common non-circular shape based on the analyzed data.

When using such a non-circular aperture in a scanner type illuminating apparatus, the difference between the critical dimensions of patterns formed perpendicular to each other can be reduced and/or minimized. Accordingly, operations to manufacture the non-circular aperture can be considered as a procedure for correcting the critical dimensions of patterns formed using a conventional circular, annular or quadrupole aperture.

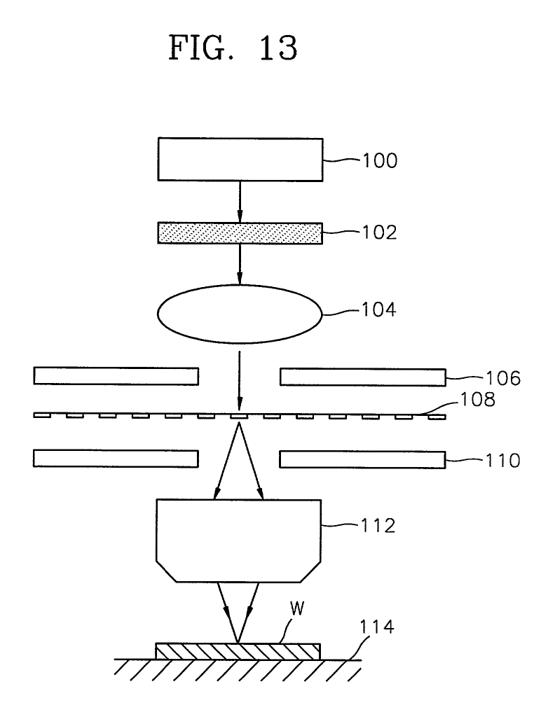

Referring now to FIG. 13, an aperture 102 is provided below a light source 100. The aperture 102 may be selected from the apertures 40, 50 and 60 described above. A condenser lens 104 is shown below the aperture 102. The aperture 102 may be positioned at the focal distance from the condenser lens 104. Accordingly, light passing through the aperture 102 and the condenser lens 104 may be changed into parallel light. In other words, light passing through the aperture 102 is incident into the condenser lens 104 in the form of a spherical wave, but light passing through the condenser lens 104 is changed into a plane wave.

First slits 106 are aligned below the condenser lens 104. A mask 108 on which patterns to be formed into the wafer W are inscribed is provided below the first slits 106. The patterns may include horizontal and vertical lines perpendicular to each other and spacers. In operation, the mask 108 may be passed (scanned) under the first slits 106 in a direction perpendicular to the lengthwise direction of the slits 106 during exposure. Accordingly, light incident into the mask 108 is restricted by the first slits 106. The first slits 106 and the aperture 102 are aligned according to particular relationship as will be understood by those of skill in the art.

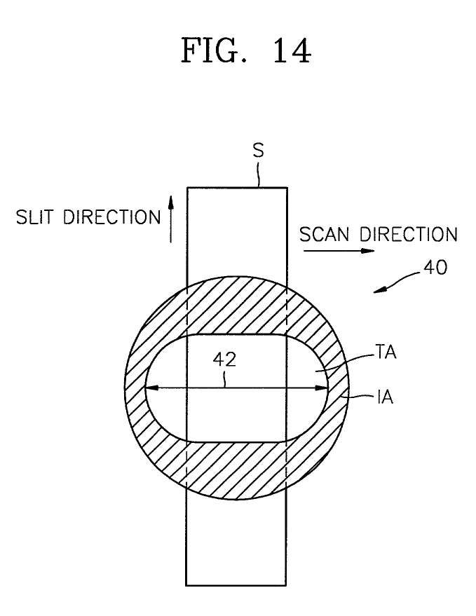

For example, when the aperture 102 is the aperture 40 as shown in FIG. 14, the aperture 40 is aligned such that the long axis 42 of the transparent area TA is parallel to the scan direction and perpendicular to the slit S direction. This alignment relationship may be maintained even when the direction of the slit S is changed.

Second slits 110 are shown as aligned under the mask 108. The second slits 110 are aligned to be parallel to the first slits 106. The second slits 110 typically do not restrict light diffracted by the mask 108 but block impure light from below, for example, reflected light. A projection lens 112 is shown in the embodiments of FIG. 13 below the second slits 110. A wafer stage 114 is provided below the projection lens 112. The projection lens 112 may be used to reduce the size of the patterns inscribed on the mask 108 and transfer them to a photosensitive film deposited on a wafer W, that is, to expose the photosensitive film to light. By developing the photosensitive film exposed to light, photosensitive film patterns substantially the same as those inscribed on the mask 108 are formed on the wafer W.

An etching process may be performed on the wafer W using the photosensitive film pattern as an etching mask, thereby forming patterns, which are substantially the same as those inscribed on the mask 108 and reduced in size, on the wafer W. Consequently, the projection lens 112 operates to reduce and transfer the patterns inscribed on the mask 108 to a predetermined area on the wafer W. During exposure, the wafer W typically moves in parallel to the mask 108.

Although many factors are specifically described in the above description, they should not be construed as restricting the scope of the present invention but are merely examples of preferred embodiments. For example, it will be understood by one of ordinary skill in the art that other types of conventional apertures than those shown in the figures, for example, a dipole aperture having two transparent areas in a shielding area, could be modified such that the shape of the two transparent areas is changed into a non-circular shape in accordance with embodiments of the present invention, and that an illuminating apparatus employing such an aperture can be provided. As described herein, an aperture according to the present invention may be applied to a scanner type illuminating apparatus, but it is to be understood that apertures according to embodiments of the present invention can be applied to other scanner type illuminating apparatus different from that shown in FIG. 13 and also may be applied to a stepper type illuminating apparatus.

In the drawings and specification, there have been disclosed typical preferred embodiments of the invention and, although specific terms are employed, they are used in a generic and descriptive sense only and not for purposed of limitation, the scope of the invention being set forth in the following claims. The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. An aperture for use in an illuminating apparatus for forming patterns in a semiconductor wafer, the aperture comprising:
a shielding area; and
at least one transparent area within the shielding area, the transparent area having an elliptical shape with an eccentricity (e) that exceeds 0 and is smaller than 1 (0<e<1).

2. The aperture of claim 1 wherein at least two of the elliptical transparent areas are provided within the shielding area.

3. The aperture of claim 1 further comprising a second shielding area within the elliptical transparent area.

4. The aperture of claim 3 wherein the second shielding area is a circular shielding area centered in the elliptical transparent area.

5. The aperture of claim 1 wherein four of the elliptical transparent areas are provided within the shielding area.

6. The aperture of claim 5 wherein the four elliptical transparent areas are positioned at angular intervals of 90° within the shielding area.

7. The aperture of claim 6 wherein each of the four elliptical transparent areas has the same eccentricity (e).

8. The aperture of claim 7 wherein the eccentricity (e) is selected to provide a desired maximum critical dimension difference between directions of the patterns.

9. An aperture for use in an illuminating apparatus for forming patterns in a semiconductor wafer, the aperture comprising:
a shielding area; and
a non-circular transparent area within the shielding area, the transparent area having a ratio of a short axis to a long axis (R=short axis/long axis) that exceeds 0 and is smaller than 1 (0<R<1), the short axis being substantially perpendicular to the long axis; and
wherein the transparent area is positioned within the shielding area to define two thin portions of the shielding area and two thick portions of the shielding area, the long axis linking the thin portions of the shielding area and the short axis linking the thick portions of the shielding area.

10. The aperture of claim 9 wherein the long axis has a 0.8 sigma (σ) length and the short axis has a 0.6 sigma (σ) length.

11. The aperture of claim 9 wherein the long axis has a 0.8 sigma (σ) length and the short axis has a 0.7 sigma (σ) length.

12. The aperture of claim 9 wherein the shielding area is circular.

13. The aperture of claim 12 further comprising a second shielding area within the transparent area.

14. The aperture of claim 13 wherein the second shielding area is a circular shielding area centered in the transparent area.

15. An illuminating apparatus for forming patterns in a semiconductor wafer, the illuminating apparatus comprising:
a wafer stage;
a light source positioned above the wafer stage;
an aperture positioned between the light source and the wafer stage;
a mask positioned between the aperture and the wafer stage;
a slit positioned between the aperture and the wafer stage; and
wherein the aperture comprises:
a shielding area; and
at least one transparent area within the shielding area, the transparent area having an elliptical shape with an eccentricity (e) that exceeds 0 and is smaller than 1 (0<e<1).

16. The illuminating apparatus of claim 15 further comprising:
a condenser lens positioned between the aperture and the mask; and
a projection lens positioned between the slit and the wafer stage.

17. The illuminating apparatus of claim 16 further comprising a second shielding area centered in the elliptical transparent area.

18. The illuminating apparatus of claim 17 wherein the first shielding area is circular.

19. The illuminating apparatus of claim 16 wherein the elliptical transparent area has a long axis with a 0.8 sigma (σ) length and a short axis with a 0.6 sigma (σ) length.

20. The illuminating apparatus of claim 16 wherein the elliptical transparent area has a long axis with a 0.8 sigma (σ) length and a short axis with a 0.7 sigma (σ) length.

21. The illuminating apparatus of claim 16 wherein at least two of the elliptical transparent areas are provided within the shielding area.

22. The illuminating apparatus of claim 21 wherein the transparent areas are positioned at specified angular intervals within the shielding area.

23. The illuminating apparatus of claim 16 wherein the aperture is aligned so that a long axis of the transparent area is perpendicular to a lengthwise direction of the slit.

24. An illuminating apparatus for forming patterns in a semiconductor wafer, the illuminating apparatus comprising:
a wafer stage;
a light source positioned above the wafer stage;
an aperture positioned between the light source and the wafer stage;
a mask positioned between the aperture and the wafer stage;
a slit positioned between the aperture and the wafer stage; and
wherein the aperture comprises:
a shielding area; and
a non-circular transparent area within the shielding area, the transparent area having a ratio of a short axis to a long axis (R=short axis/long axis) that exceeds 0 and is smaller than 1 (0<R<1), the short axis being substantially perpendicular to the long axis; and
wherein the transparent area is positioned within the shielding area to define two thin portions of the shielding area and two thick portions of the shielding area, the long axis linking the thin portions of the shielding area and the short axis linking the thick portions of the shielding area.

25. The illuminating apparatus of claim 24 further comprising:
a condenser lens positioned between the aperture and the mask; and
a projection lens positioned between the slit and the wafer stage.

26. An illuminating apparatus for forming patterns in a semiconductor wafer, the illuminating apparatus comprising:
a wafer stage;
a light source positioned above the wafer stage;
an aperture positioned between the light source and the wafer stage;
a mask positioned between the aperture and the wafer stage;
a slit positioned between the aperture and the wafer stage, the slit having a lengthwise axis perpendicular to a scan direction of the illuminating apparatus; and
wherein the aperture comprises:
a shielding area; and
a non-circular transparent area within the shielding area, the transparent area having a ratio of a short axis to a long axis (R=short axis/long axis) that exceeds 0 and is smaller than 1 (0<R<1), the short axis being substantially perpendicular to the long axis; and
wherein the slit moves relative to the mask in the scan direction during forming of the patterns and wherein the aperture is aligned so that the long axis of the transparent area is perpendicular to the lengthwise axis of the slit.

27. The illuminating apparatus of claim 26 further comprising:
a condenser lens positioned between the aperture and the mask; and
a projection lens positioned between the slit and the wafer stage.
